(19) United States
(12) Patent Application Publication
(10) Pub. No.: US 2006/0107278 A1
(43) Pub. Date: May 18, 2006

(54) Magnetic multilayer film and magneto-optical recording medium using magnetic multilayer film

(75) Inventors: Fumitake Itoh, Gunma (JP); Hiroshi Sakurai, Gunma (JP); Tadashi Kato, Gunma (JP); Xioix Liu, Nagano (JP)

Correspondence Address: HOGAN & HARTSON L.L.P., 500 S. GRAND AVENUE, SUITE 1900, LOS ANGELES, CA, 90071-2611, US

(73) Assignee: National University Corporation GUNMA UNIVERSITY

(21) Appl. No.: 11/129,557

(22) Filed: May 13, 2005

(30) Foreign Application Priority Data
Nov. 16, 2004 (JP) 332282/2004 (PAT.

(51) Int. Cl. G11B 11/00; G11B 5/127; G11B 5/33; G11B 7/24; G11B 23/03

(52) U.S. Cl. 720/718; 369/13.35

(57) ABSTRACT

A magnetic multilayer film 10 includes a structure in which thin films 11 made of a ferromagnetic material and thin films 12 made of an insulating material are alternately laminated with each other. Also, a magneto-optical recording medium has a recording film (magneto-optical film) for recording information, the recording film composed of this magnetic multilayer film 10. A magnetic multilayer film has a large magneto-optic effect and it is excellent in stability. A magneto-optical recording medium uses this magnetic multilayer film.

### BACKGROUND OF THE INVENTION

1. Field of the Invention

The present invention relates to a magnetic multilayer film having a large Kerr rotation angle suitable for the application as a material that can record and detect magnetic information by using light, for example. Also, this invention relates to a magneto-optical recording medium using this magnetic multilayer film as a recording film.

2. Description of the Related Art

In order to record magnetic information with high recording density or to detect magnetic information with high sensitivity, it is requested that a magneto-optical recording medium should have high recording density, a magneto-optical recording medium should have a large magneto-optic effect, a magneto-optical recording medium with a large area can be manufactured homogeneously and inexpensively and that a magneto-optical recording medium should be excellent in stability.

In particular, a magneto-optic effect in the multilayer structure has received a remarkable attention so far because there is a possibility that it will be useful for realizing a recording medium with a high recording density (for examples see cited non-patent reference 1 or cited non-patent reference 2).

As materials which can meet such requirements, there have been so far used a polycrystal material such as MnBi, MnCuBi and MnCo, a single crystal material such as rare earth garnet or amorphous alloy such as GdCo, GdFe and TbFeCo.

At the present time, amorphous alloys of rare earth and transition metals become the main current of magneto-optical recording materials.

These materials have merits in which they can be manufactured by a simple method, they are high in recording sensitivity, they can record magnetic information at high recording density and in which they are low in media noise because they have no grain boundary.

In a magneto-optical recording medium such as a magneto-optical disc, a method for writing (recording) information to be recorded based upon a magnetic change of a recording film made of a ferromagnetic material thin film by using laser light and for reproducing recorded information by reading out the magnetic change of the recording film from the change of a Kerr rotation angle of laser light is used as a powerful magnetic optical recording system.

[Cited non-patent reference 1]: Y. Ochiai, S. Hashimoto and K. Aso, IEEE Trans. Magn. 25, 1989, p. 3755.

[Cited non-patent reference 2]: S. Hashimoto, Y. Ochiai and K. Aso, J. Appl. Phys. 67, 1990, p. 4429.

However, since the above-mentioned amorphous alloy of the rare earth and the transition metal is the amorphous alloy having a small Kerr rotation angle, problems arise, in which such amorphous alloy will be crystallized, it will be oxidized so that it is poor in stability and the like.

Then, in order to make it possible to record magnetic information at high recording density and in order to make it possible to detect recorded information at high sensitivity, magnetic materials that can overcome the drawbacks inherent in the related-art materials are desired.

### SUMMARY OF THE INVENTION

In view of the aforesaid aspect, the present invention intends to provide a magnetic multilayer film having a large magneto-optic effect and which is excellent in stability and a magneto-optical recording medium using this magnetic multilayer film.

According to an aspect of the present invention, there is provided a magnetic multilayer film having a structure in which thin films made of a ferromagnetic material and thin films made of an insulating material are alternately laminated with each other.

Specifically, this magnetic multilayer film has a structure in which thin films made of a ferromagnetic material T having a thickness x and thin films made of an insulating material I having a thickness y are alternately laminated with other at the repetitions n.

In the magneto-optical recording medium according to the present invention, a recording film for recording information, that is, a magneto-optical film is comprised of the above-described magnetic multilayer film of the present invention.

The assignee of the present invention has discovered that, when a magnetic multilayer film having an artificial lattice structure in which thin films made of a ferromagnetic material and thin films made of an insulating material are alternately laminated with each other is formed, this magnetic multilayer film exhibits a Kerr effect increasing phenomenon 1.5 times to 2 times as large as that of a magnetic film composed of a single substance of a magnetic material film in the whole region with a wavelength ranging of from 400 to 900 nm.

For example, when a ferromagnetic material is selected to be Fe, an Fe film has a film thickness ranging of from 1 to 2 nm. Also, when the insulating material has a film thickness ranging of from 1 to 2 nm, this Kerr effect increasing phenomenon is exhibited.

It can be considered that this Kerr effect increasing phenomenon is caused by deposited state of an artificial lattice of the ferromagnetic materials and the insulating materials which are alternately laminated with each other.

A ferromagnetic material is a metal, an alloy, a ferrite and the like and it has a relatively high reflectance relative to light. On the other hand, the insulating material has a relatively high transmittance relative to light.

Accordingly, when light is introduced into the magnetic multilayer film in which the thin films made of the ferromagnetic material and the thin films made of the insulating material are alternately laminated with each other, light is reflected on the respective ferromagnetic material films. Reflected lights (multiplexed reflected lights) from these ferromagnetic material films strengthen with each other to increase a magneto-optic effect and they act to increase a Kerr rotation angle.

Also, since an artificial cycle is formed of the thin films made of the ferromagnetic material and the thin films made of the insulating material, this artificial cycle causes an action in which multiplexed reflected light interfere with each other. Further, since the insulating material is inserted into the ferromagnetic materials, there occurs a magnetic mutual action between the ferromagnetic materials.

These actions are operated in an integrated fashion, whereby the magneto-optic effect can be increased.

According to the above-mentioned magnetic multilayer film of the present invention, the magneto-optic effect can be increased and hence the Kerr rotation angle can be increased.

Also, since the magnetic multilayer film according to the present invention has the structure in which the thin films made of the ferromagnetic material and the thin films made of the insulating material are alternately laminated with each other and the thin films made of the ferromagnetic material and the thin films made of the insulating material can be easily deposited by a suitable method such as a vapor deposition method and a sputtering method, the magnetic multilayer film according to the present invention can be manufactured easily and inexpensively. Thus, the magnetic film with the large area can be manufactured homogeneously and inexpensively and also the magnetic film which is excellent in stability can be realized.

Then, since the magnetic multilayer film is used as the recording film to construct the magneto-optical recording medium and the recording film has the large Kerr rotation angle, recording sensitivity is high and hence recorded information can be detected at high sensitivity. As a consequence, a recording capacity of the magneto-optical recording medium can be increased. Also, it becomes possible to miniaturize a magneto-optical recording apparatus by reducing the size of the disc such as its diameter.

Further, since the magnetic multilayer film is excellent in stability, the magneto-optical recording medium using the magnetic multilayer film, optical communication equipment such as an optical isolator, a magneto-optical holography and a magnetic detector can be improved in reliability.

### BRIEF DESCRIPTION OF THE DRAWINGS

FIG. 1 is a schematic diagram showing an arrangement of a magnetic multilayer film according to an embodiment of the present invention;

FIG. 2 is a schematic cross-sectional view showing the manner in which lights, which were introduced into the magnetic multilayer film shown in FIG. 1, are reflected;

FIG. 3 is a schematic diagram showing an arrangement of a magneto-optical recording medium using the magnetic multilayer film shown in FIG. 1;

FIG. 4 is a diagram showing measured results of X-ray diffraction in the magnetic multilayer film shown in FIG. 1;

FIG. 5 is a diagram showing the manner in which saturation magnetization is changed depending upon the film thickness of the insulating material in the magnetic multilayer film shown in FIG. 1;

FIG. 6 is a diagram of characteristic curves showing measured results obtained when spectrums of Kerr rotation angle of the magnetic film shown in FIG. 1 were measured while the film thickness of the insulating material film was being changed;

FIG. 7 is a diagram of characteristic curves showing measured results obtained when spectrums of the Kerr rotation angle of the magnetic film shown in FIG. 1 were calculated while the film thickness of the insulating material film was being changed; and

FIG. 8 is a diagram showing a relationship between the Kerr rotation angle and film thicknesses of the insulating material film at a wavelength of 660 nm in the magnetic film shown in FIG. 1.

### DESCRIPTION OF THE PREFERRED EMBODIMENTS

The present invention will now be described with reference to the drawings.

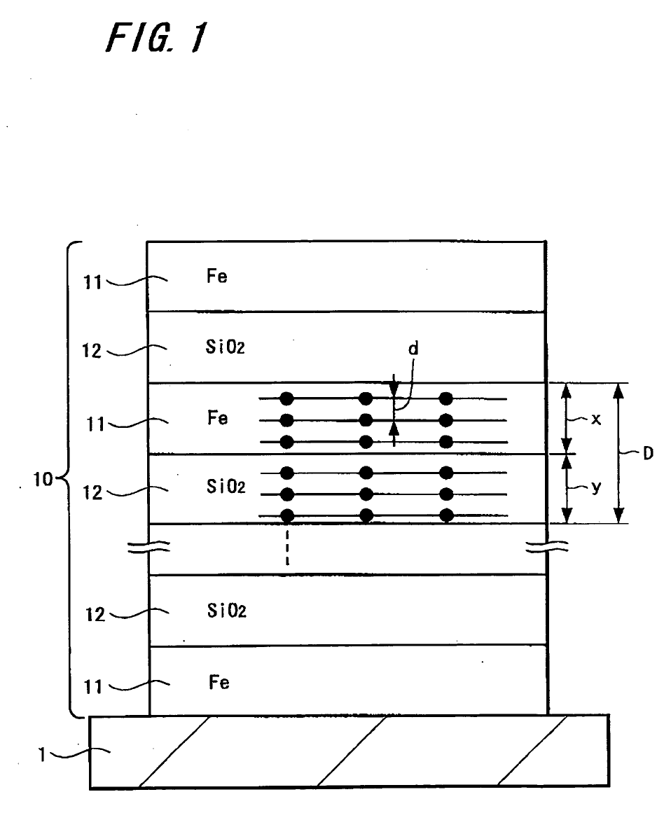

FIG. 1 of the accompanying drawings is a schematic diagram showing an arrangement of a magnetic multilayer film as a magnetic multilayer film according to an embodiment of the present invention.

As shown in FIG. 1, this magnetic multilayer film has an arrangement in which multilayers of ferromagnetic material layers 11 made of Fe and multilayers of insulating material films 12 made of SiO₂ are alternately laminated on a substrate 1 with each other to thereby construct a magnetic multilayer film (laminated film) 10.

Within the respective layers 11 and 12 comprising the magnetic multilayer film 10, layer-like lattices made of atoms and molecules are formed with a spacing d.

Then, the total sum of a film thickness x of the ferromagnetic material film 11 and a film thickness y of the insulating material film 12 becomes a cycle D of an artificial lattice, and the ferromagnetic material film 11 and the insulating material film 12 are alternately laminated with each other at this cycle D.

This magnetic multilayer film 10 can be expressed as [T (x)/I(y)]ₙ where a film thickness of the ferromagnetic material film 11 made of a ferromagnetic material T (for example, Fe) is assumed to be x[nm], a film thickness of the insulating material film 12 made of an insulating material I (for example, SiO₂) is assumed to be y[nm] and the number of repetitions is assumed to be n.

The Fe film of the ferromagnetic material film 11 and the SiO₂ film of the insulating material film 12 can be deposited by a vapor deposition method of a sputtering method while Fe and SiO₂ are used as targets.

Then, the respective film thicknesses x and y can be controlled easily by adjusting energizing power and a deposition time.

Also, while the magnetic multilayer film 10 shown in FIG. 1 uses the Fe film as the ferromagnetic material film 11 and the SiO₂ film as the insulating material film 12, the present invention is not limited thereto and the ferromagnetic material film and the insulating material film can be made of other ferromagnetic materials and insulating materials.

A Kerr rotation angle increasing effect in the magnetic multilayer film according to the present invention is caused by an artificial lattice obtained by a combination of a ferromagnetic material film and an insulating material film, each having a relatively thin film thickness of about nm, and it can be obtained regardless of the kinds of the ferromagnetic material and the insulating material. As the ferromagnetic material for use with the ferromagnetic material film, there can be used more than one kind of ferromagnetic material selected from Fe, Co, Ni, Fe₃O₄, ferromagnetic alloys containing transition metals and ferromagnetic compounds. For example, there can be numerated MnNi, MnCuBi, MnCo, GdCo. GdFe, TbFeCo, Fe₃O₄ and the like.

As the insulating material for use with the insulating material film, there can be used more than one kind of insulating material selected from SiO₂, Al₂O₃ and MgF₂.

The ferromagnetic material film is made of metal, alloy, ferrite and the like and hence it has a relatively high reflectance relative to light.

On the other hand, the insulating material film has a relatively high transmittance relative to light. In particular, the insulating material film may be made of an insulating material of glass quality having a high light transmittance such as SiO₂.

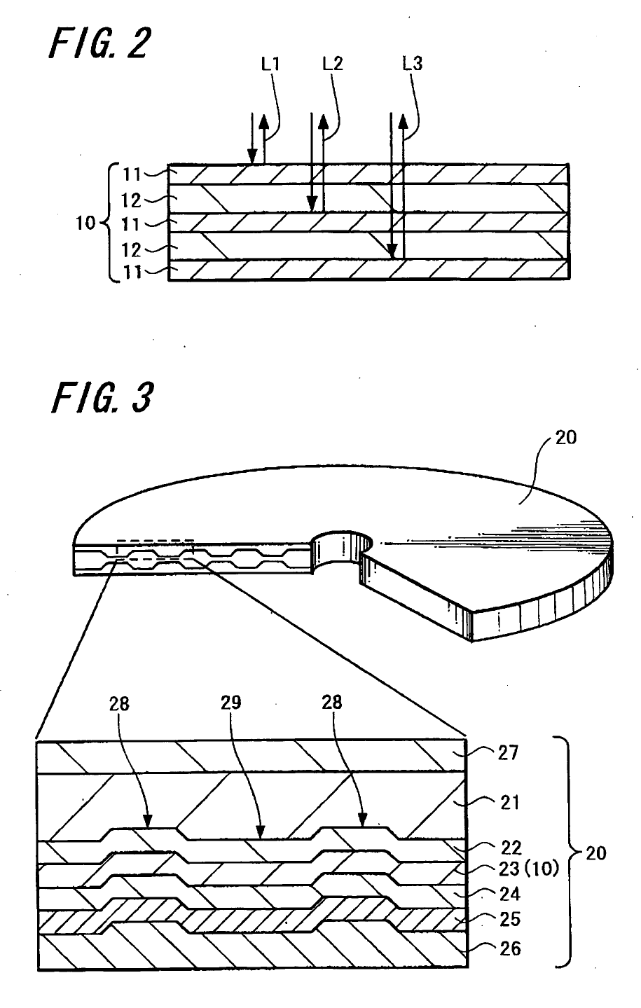

Accordingly, when light is introduced into the magnetic multilayer film 10 shown in FIG. 1, lights are reflected on the respective magnetic multilayer films 11 as shown in a schematic cross-sectional view of FIG. 2.

Then, as shown by arrows in FIG. 2, reflected light L1 reflected on the ferromagnetic material film 11 of the first layer, reflected light L2 reflected on the ferromagnetic material film 11 of the second layer and reflected light L3 reflected on the ferromagnetic material film 11 of the third layer are adapted to strengthen to each other.

As described above, when the lights multiplied and reflected on the respective ferromagnetic material films 11 strengthen to each other, a magneto-optic effect can be increased and hence a Kerr rotation angle can be increased.

Also, since the artificial cycle D is composed of the ferromagnetic material film 11 and the insulating material film 12, this artificial cycle D causes an action in which Multiplexed reflected lights interfere with each other. Also, since the insulating material film 12 is inserted into the ferromagnetic material films 11, magnetic mutual action occurs between the ferromagnetic material films 12.

The magneto-optic effect can also be increased by integrated action of these actions.

In the ferromagnetic material film 11, its film thickness x can be prevented from being decreased too much. The film thickness of the ferromagnetic material film 11 may be selected to be approximately such one that can prevent properties (magnetic properties, etc.) of the bulk of the ferromagnetic material from being lost.

According to the above-mentioned magnetic multilayer film 10 of this embodiment, since the ferromagnetic material films 11 and the insulating material films 12 are alternately laminated to each other in a multilayer fashion, the ferromagnetic material film 11 can have a relatively high reflectance relative to light and the insulating material film 12 can have a relatively high transmittance relative to light. When light is introduced into the magnetic multilayer film 10, lights are reflected on the respective ferromagnetic material films 11. Reflected lights (multiplexed and reflected lights) on these respective ferromagnetic material films 11 strengthen each other and they act so as to increase the magneto-optic effect to increase the Kerr rotation angle.

The artificial cycle D formed by the ferromagnetic material film 11 and the insulating material film 12 causes the multiplexed and reflected lights to interfere with each other. Also, the magnetic mutual action occurs between the ferromagnetic material films 11.

These actions are operated in an integrated fashion and hence the magneto-optic effect can be increased.

Accordingly, it is possible to construct the magnetic film having the large kerr rotation angle by increasing the magneto-optic effect.

Also, since the ferromagnetic material film 11 and the insulating material film 12 can be easily deposited by a suitable method such as the vapor deposition method and the sputtering method, the magnetic multilayer films 10 according to this embodiment can be manufactured easily and inexpensively. As a consequence, the magnetic film with the large area can be manufactured homogeneously and inexpensively. Also, it is possible to realize the magnetic film which is excellent in stability.

Then, it is possible to construct a magneto-optical recording medium by using the magnetic multilayer film 10 according to this embodiment as its recording film.

For example, it is possible to construct a disc-like magneto-optical recording medium 20 having a structure shown in FIG. 3 by using the magnetic multilayer film 10 as a magneto-optical film (recording film) 23.

The magneto-optical recording medium 20 according to the embodiment shown in FIG. 3 has a substrate 21 made of a polycarbonate resin in which groove portions extending along the circumferential direction, that is, grooves 28 are formed. On this substrate 21, there are laminated a dielectric film 22, a magneto-optical film (recording film) 23, a dielectric film 24 and a reflecting film 25, and protective films 26 and 27, each made of a ultraviolet-curing resin, are formed on lower and upper surfaces, respectively.

The magneto-optical film (recording film) 23 is able to record information with illumination of light and with application of a magnetic field and it is composed of the magnetic multilayer film (laminated film) 10 in which the ferromagnetic material films 11 and the insulating material films 12 shown in FIG. 1 are alternately laminated with each other.

This magneto-optical recording medium 20 has an arrangement in which a portion formed between the grooves 28 of the substrate 21, that is, a land portion 29 is used as a recording portion. Then, the magnetized state of the magnetic material is recorded on the magneto-optical film (recording film) 23 of the land portion 29 as information.

Light for recording information and reading (reproducing) information is irradiated on the side of the substrate 21 of the magneto-optical recording medium 20, that is, it is irradiated from the upper side of FIG. 3 and introduced into the magneto-optical film (recording film).

Then, since the magneto-optical film (recording film) 23 is comprised of the magnetic multilayer film 10 shown in FIG. 1, the Kerr rotation angle in the magneto-optical film (recording film) 23 is large so that recording sensitivity is high and that recorded information can be detected at high sensitivity. As a consequence, it becomes possible to increase the recording capacity of the magneto-optical recording medium 20 and also it becomes possible to miniaturize a magneto-optical recording apparatus by reducing the size such as the diameter of the disc.

The magneto-optical recording medium according to the present invention is not limited to the layer arrangement of the embodiment of the magneto-optical recording medium 20 shown in FIG. 3 and the layer arrangement of the magneto-optical recording medium of the present invention, in particular, is not limited insofar as a magneto-optical recording medium has an arrangement in which a recording film (magneto-optical film) is comprised of the magnetic multilayer film.

Then, while the disc-like medium shown in FIG. 3 is generally used as the magneto-optical recording medium, according to the present invention, the shape of the magneto-optical recording medium is not limited to the disc-like shape, in particular, and it can be formed as a card-like shape or other shapes.

The magnetic multilayer film according to the present invention is not limited to the magneto-optical recording medium and it can also be applied to other recording mediums using a magneto-optic effect, magnetic properties and the like. For example, the magnetic multilayer film according to the present invention can generally be applied to optical communication equipment such as an optical isolator, a magneto-optical holography, a magnetic detector and the like.

Then, since the magnetic multilayer film is excellent in stability, it is possible to improve reliability of the magneto-optical recording medium using the magnetic multilayer film, the optical communication equipment such as the optical isolator, the magneto-optical holography, the magnetic detector and the like.

### INVENTIVE EXAMPLE

Next, magnetic multilayer films according to the present invention were manufactured in actual practice and their characteristics were checked.

A ferromagnetic material film 11 made of an Fe film having a film thickness 2 nm and an insulating material film 12 made of an SiO₂ film were alternately and repeatedly laminated on the substrate 1 and thereby the multilayer film structure 10 shown in FIG. 1 was formed. This multilayer film structure 10 was used as a test sample.

Then, the film thickness y(nm) of the SiO₂ film was changed by adjusting energizing power and a deposition time and thereby test samples of the respective magnetic multilayer films were produced. The respective test samples were manufactured by adjusting the repetition number n in such a manner that the total thickness of the multilayer film structure 10 may become approximately 1 μm.

When this multilayer film structure is expressed by the aforementioned symbols, it can be expressed as [Fe(2)/SiO₂(y)].

(1) Measurement of X-ray Diffraction Pattern:

First, X-ray diffraction patterns of the respective test samples of the magnetic multilayer film were measured.

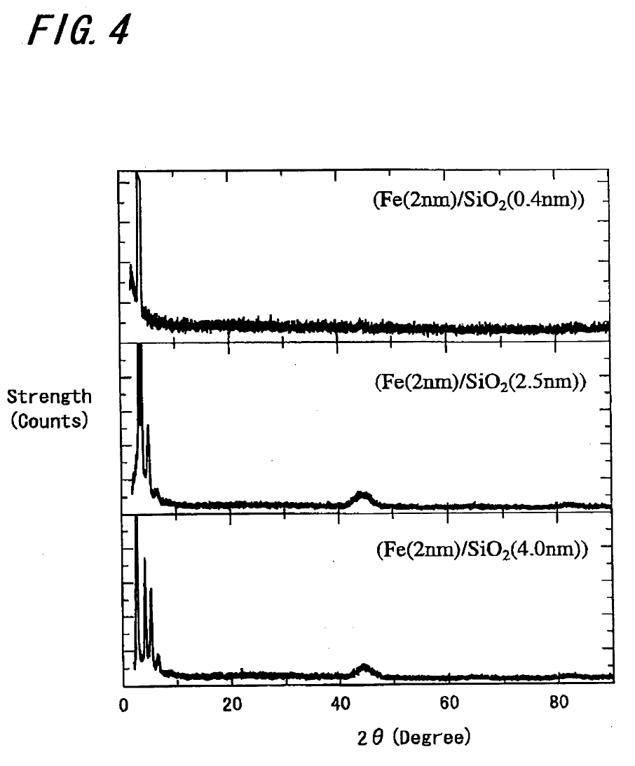

FIG. 4 is a diagram showing measured results of the respective test samples obtained when the film thickness y of the insulating material film 12 was selected to be 0.4 nm, 2.5 nm and 4.0 nm.

In FIG. 4, peaks observed in small angle regions of less than 7 degrees indicate a cycle of an artificial lattice. From FIG. 4, the cycle D of the artificial lattice and the chemical structure formula can be confirmed.

Also, a slightly wide diffraction line near 2θ=44 degrees shows a diffraction line of an Fe (110) and it shows that the Fe film holds an Fe fundamental structure (body-centered cubic structure; bcc structure) in the bulk state although it is slightly disturbed.

Further, although a diffraction line is not observed because strength of the vertical axis is small in FIG. 4, if the vertical axis is magnified, then a wide diffraction line can be observed in a middle angle region near 2θ=20 degree. This wide diffraction line in the middle angle region indicates that the SiO₂ layer is placed in the amorphous state. These diffraction lines show that these test samples had formed the artificial lattice in which the Fe layer and the SiO₂ layer are alternately deposited at the cycle D.

Nearly similar results were obtained from test samples ion which the film thickness of the insulating material film 12 was selected to be other film thicknesses.

(2) Measurement of Magnetization:

Test samples of magnetic multilayer films were produced while the film thickness y(nm) of the SiO₂ film of the insulating material film 12 was changed to 0.2 nm, 0.4 nm, 1.0 nm, 1.5 n=, 2.0 nm and 2.5 nm.

The respective test samples were manufactured by adjusting the repetition number n in such a manner that the total thickness of the multilayer film structure 10 may become approximately 1 μm. Also, a bulk Fe film having a thickness of approximately 1 μm was manufactured as a test sample for comparison and contrast.

Magnetization curves of the respective test samples were measured by a superconductive quantum interference device (SQUID) and a saturation magnetization δ in the in-plane direction was calculated from the magnetization curves. FIG. 5 shows measured results. In FIG. 5, the saturation magnetization δ of the test sample of the Fe film for comparison and contrast was shown at the portion having a thickness of 0 nm.

It is to be understood from FIG. 5 that the saturation magnetization δ is monotonically decreased as the thickness of the SiO₂ film of the insulating material film 12 is increased. The reason for this is to be understood that the magnetic mutual action between the ferromagnetic material films 11 is blocked by the insulating material film 12 and decreased.

In a range in which the film thickness of the SiO₂ film is less than 0.4 nm, a difference between the saturation magnetization δ and a magnetization of the single substance of the Fe film is decreased.

(3) Measurement of Kerr Rotation Angle:

Test samples of respective magnetic multilayer films were produced while the film thickness y(nm) of the SiO₂ film of the insulating material film 12 was changed to 0.4 nm, 2.5 nm, 4 nm, 12 nm and 16 nm. The respective test samples were manufactured by adjusting the repetition number n in such a manner that the total thickness of the multilayer film structure 10 may become approximately 1μ.

With respect to the respective test samples, light with a predetermined wavelength was illuminated on their magnetic films and their rotation angles relative to the light with the predetermined wavelength were measured. Then, the wavelength of the light irradiated on the magnetic films was changed within a range of from 500 nm to 900 nm and Kerr rotation angles of the test samples were measured. Also, Kerr rotation angle of the test sample of the Fe film of the bulk having the thickness of 1 μm and which is for use in comparison and contrast was measured.

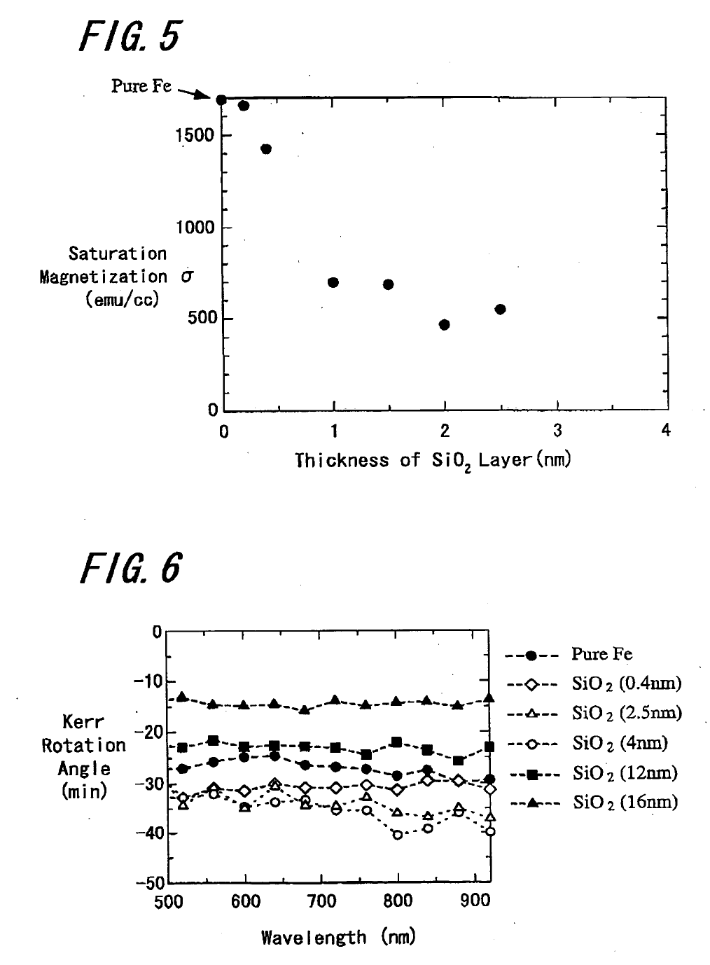

FIG. 6 is a diagram showing spectrums of the Kerr rotation angles θ_{K} as measured results.

From FIG. 61 such a phenomenon was observed in which the Kerr rotation angle θ_{K} is first increased in all measured wavelength regions as the film thickness y of the insulating material film is increased, it exhibits the maximum value in the region near y=2 to 4 nm and it begins to decrease as the film thickness y is increased more. It is to be considered that the increase of the Kerr rotation angle θ_{K} is caused by multiple scattering of light between the layers and that the decrease of the Kerr rotation angle θ_{K} is caused by the decrease of magnetic mutual action between the ferromagnetic material films 11. Due to both of the above-mentioned actions, the Kerr rotation angle θ_{K} has the maximum value.

Although the wavelength position at which the Kerr rotation angle θ_{K} exhibits the maximum value becomes slightly different depending upon the film thickness y of the insulating material film, the maximum value of the Kerr rotation angle θ_{K} is increased to be 1 to 1.5 times as compared with that of the pure Fe film.

The Kerr rotation angle θ_{K} of the artificial lattice multilayer film can be obtained by calculation based on a virtual optical constant method and it is given by the following equation (1):
θ_{K}=Re(E_{xy}/√Eₓₓ(1−Eₓₓ) (1)
E_{xy}=(N_{L}⁺²−N_{L}⁻²)/2i (2)
Eₓₓ=(N_{L}⁺²−N_{L}⁻²)/2 (3)

Also, N_{L}⁺ and N_{L}⁻ represent virtual optical constants of a bilayer film relative to right (+) circularly-polarized light and left (−) circularly-polarized light each having a wavelength of λ, and these are given as in the following equations (4) to (6) by using an optical constant n₁⁺⁻ of an upper layer (thickness h₁) and an optical constant n₂⁺⁻ of a lower layer:

$$\begin{matrix}{N}^{+ -} = {n}_{l}^{+ -} \frac{1 - {r}^{+ -} exp ( - 2 {ⅈΦ}^{+ -}}{1 + {r}^{+ -} exp ( - 2 {ⅈΦ}^{+ -}} & ( 4 ) \\ {r}^{+ -} = \frac{{n}_{1}^{+ -} - {n}_{2}^{+ -}}{{n}^{+ -} + {n}_{2}^{+ -}} & ( 5 ) \\ {Φ}^{+ -} = 2 π {n}_{1}^{+ -} {h}_{1} / λ & ( 6 )\end{matrix}$$

It is known that this theoretical equation can well explain the magneto-optic effect if it is applied to the artificial lattice multilayer film (for example, see “METAL ARTIFICIAL LATTICE”, published by AGNE GIJUTSU CENTER, 1995).

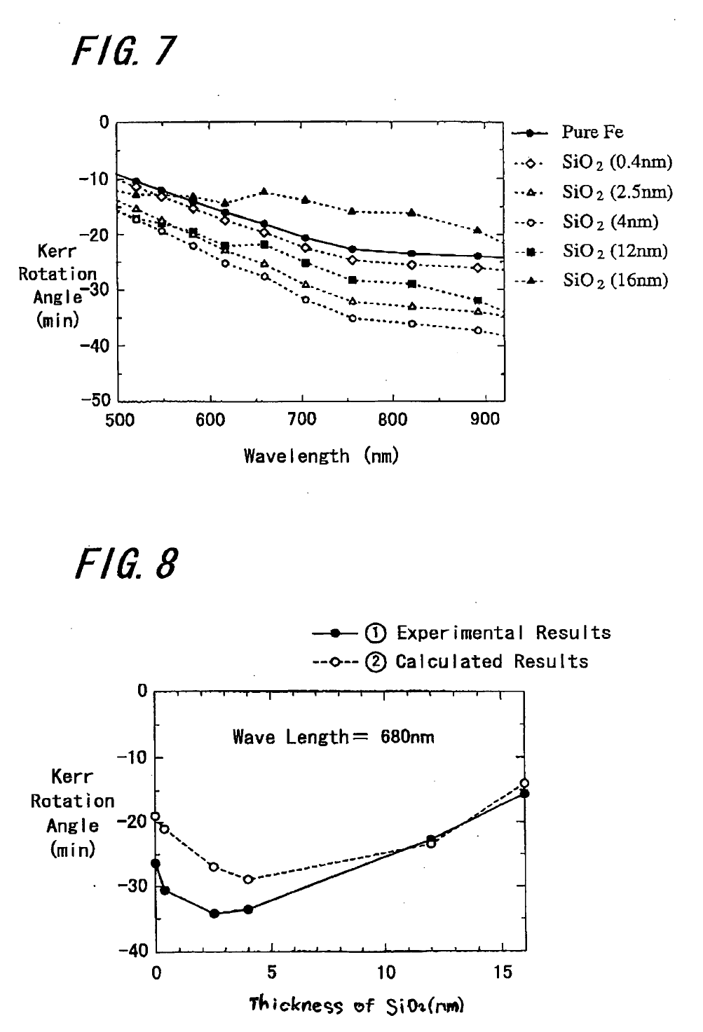

FIG. 7 is a diagram showing spectrums of the Kerr rotation angle θ_{K} of the magnetic multilayer film [Fe (2)/SiO₂ (y)]ₙ obtained by calculation using the above-mentioned virtual optical constant method. Optical constants of the Fe film and the SiO₂ film were reference values.

A study of FIG. 7 reveals that the Kerr rotation angle can be increased when the SiO₂ film is inserted into the Fe films and that the Kerr rotation angle can become a maximum value when the film thickness y of the SiO₂ film is 4 nm. Thus, it is to be understood that calculated values well correspond to experimental values.

Accordingly, it can be considered that the increase of the magneto-optic effect of the artificial lattice magnetic multilayer film 10 formed by laminating the ferromagnetic materials and the insulating materials is caused by the increase of multiple reflection from the interface between the ferromagnetic material and the insulating material, it is increased by light interference action caused by the cyclic artificial lattice and that it is increased by the magnetic mutual action caused between the ferromagnetic materials by the insertion of the insulating material into the ferromagnetic materials. Also, it is to be understood that, when the above-mentioned actions are operated in an integrated fashion, the Kerr rotation angle θ_{K} is changed with the film thickness of the insulating material.

FIG. 8 is a diagram of characteristic curves of the experimental values shown in FIG. 6 and the calculated values shown in FIG. 7 showing plotted results of the Kerr rotation angles θ_{K} changed with the film thickness y of the SiO₂ film when the artificial lattice multilayer film [Fe(2 nm)/SiO₂(y)]ₙ is illuminated with light having a constant wavelength of 660 nm.

A study of FIG. 8 reveals a phenomenon in which the Kerr rotation angle θ_{K} is first increased as the film thickness y of the SiO₂ film is increased, it reaches the maximum value in the wavelength region near y=2 to 4 nm and it is decreased as the film thickness y is increased more. Thus, it is to be understood that the experiment and the theory are substantially coincident with each other.

(4) Study of Various Kinds of Ferromagnetic Materials:

As mentioned hereinbefore, it is to be understood that the effect for increasing the Kerr rotation angle according to the present invention is a general characteristic which does not depend on the materials of the ferromagnetic material and the insulating material.

Accordingly, simulation calculations were effected on Kerr rotation angles of various kinds of artificial lattice magnetic multilayer films formed by combinations of various kinds of materials of ferromagnetic materials and insulating materials while the film thickness of the ferromagnetic material was fixed to 2 nm and the film thickness y(nm) of the insulating material was used as a function. A wavelength λ of light was fixed to 633 nm (this wavelength corresponds to a wavelength of an He—Ne laser).

As a result, it could be understood that the Kerr rotation angle exhibits the maximum value regardless of the material of the ferromagnetic material when the insulating material has a certain film thickness similarly to FIG. 8.

Calculated results of respective materials are shown in the following table 1. The table 1 shows the kinds and film thicknesses of the ferromagnetic materials, the kinds of the insulating materials and the insulating material film thicknesses by which the Kerr rotation angle can exhibit the maximum value, Kerr rotation angles and the Kerr rotation angle increasing ratios (ratio of the Kerr rotation angle of the artificial lattice multilayer film relative to the Kerr rotation angle of the single substance of the ferromagnetic material), in that order.

TABLE 1

| | | Insulating | | | |
|---|---|---|---|---|---|
| | | material | | | |
| | | | Film | | Increasing |
| Ferromagnetic | | | thickness | Kerr | ratio of |
| material | | | indicating | rotation | Kerr |
| | Film | | maximum | angle | rotation |
| Material | thickness | Material | value (nm) | (min) | angle |
| Fe | 2 | SiO₂ | 2 | −41.7 | 1.2 |
| Co | 2 | SiO₂ | 8 | −35.7 | 2.64 |
| Ni | 2 | SiO₂ | 8 | −4.42 | 1.73 |
| MnBi | 2 | SiO₂ | 3 | −54.4 | 1.32 |
| TbFeCo | 2 | SiO₂ | 2 | −15.7 | 1.3 |
| Fe₃O₄ | 1 | SiO₂ | 16 | 18.35 | 2.09 |
| Fe₃O₄ | 8 | Al₂O₃ | 16 | 14.75 | 1.68 |

From the table 1, it becomes clear that, although the insulating material film thickness by which the Kerr rotation angle can exhibit the maximum value is changed with the material of the ferromagnetic material, the film thickness ratio (film thickness of insulating material/film thickness of ferromagnetic material) falls within a range of from 1 to 8 and that the Kerr rotation angle increasing ratio becomes 1.2 to 2.0 times.

The magnetic multilayer film according to the present invention can generally be magneto-optical recording mediums, optical communication equipment such as an optical isolator, a magneto-optical holography, a magnetic detector and the like.

According to the above-mentioned magnetic multilayer film of the present invention, the magneto-optic effect can be increased and hence the Kerr rotation angle can be increased.

Also, since the magnetic multilayer film according to the present invention has the structure in which the thin films made of the ferromagnetic material and the thin films made of the insulating material are alternately laminated with each other and the thin films made of the ferromagnetic material and the thin films made of the insulating material can be easily deposited by a suitable method such as a vapor deposition method and a sputtering method, the magnetic multilayer film according to the present invention can be manufactured easily and inexpensively. Thus, the magnetic film with the large area can be manufactured homogeneously and inexpensively and also the magnetic film which is excellent in stability can be realized.

Then, since the magnetic multilayer film is used as the recording film to construct the magneto-optical recording medium and the recording film has the large Kerr rotation angle, recording sensitivity is high and hence recorded information can be detected at high sensitivity. As a consequence, a recording capacity of the magneto-optical recording medium can be increased. Also, it becomes possible to miniaturize a magneto-optical recording apparatus by reducing the size of the disc such as its diameter.

Further, since the magnetic multilayer film is excellent in stability, the magneto-optical recording medium using the magnetic multilayer film, optical communication equipment such as an optical isolator, a magneto-optical holography and a magnetic detector can be improved in reliability.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic multilayer film including a structure in which thin films made of a ferromagnetic material and thin films made of an insulating material are alternately laminated with each other.

2. A magnetic multilayer film according to claim 1, wherein said ferromagnetic material is more than one kind of ferromagnetic materials selected from Fe, Co, Ni, Fe₃O₄, a ferromagnetic alloy containing a transition metal and a ferromagnetic compound and said insulating material is more than one kind of insulating materials selected from SiO₂, Al₂O₃ and MgFe₂.

3. A magneto-optical recording medium including a recording film for recording information, said recording film composed of a magnetic multilayer film in which thin films made of a ferromagnetic material and thin films made of an insulating material are alternately laminated with each other.
